(19) United States
(12) Patent Application Publication
(10) Pub. No.: US 2017/0160567 A1
(43) Pub. Date: Jun. 8, 2017

(54) CLIP-ON EYEGLASSES AND BRIDGE DEVICE

(71) Applicant: Oceanus Investment Inc., Mahe (SC)

(72) Inventors: David CHAO, Saratoga, CA (US); Zhao-Yun HE, Shenzhen (CN)

(21) Appl. No.: 15/366,334

(22) Filed: Dec. 1, 2016

(30) Foreign Application Priority Data
Dec. 4, 2015 (CN) 201521001613.3

(51) Int. Cl. G02C 9/04; G02C 5/06; G02C 7/10

(52) U.S. Cl. CPC G02C 9/04; G02C 7/10; G02C 5/06; G02C 2200/26

(57) ABSTRACT

A pair of clip-on eyeglasses includes two rims and a bridge device. The bridge device includes a main body and a connecting unit. The main body has first and second end portions, and is formed with a slide groove that extends therebetween and that has a non-circular cross section perpendicular to an extending direction. The connecting unit has a first connecting element having a first rod member connected to one of the rims, and a second connecting element having a slide block member that is slidable and non-rotatable along the slide groove and that has a non-circular cross section perpendicular to the extending direction, a second rod member connected to the slide block member and the other one of the rims, and a resilient member sleeved on the second rod member.

### CROSS-REFERENCE TO RELATED APPLICATION

This application claims priority of Chinese Patent Application No. 201521001613.3, filed on Dec. 4, 2015.

### FIELD

This disclosure relates to a pair of clip-on eyeglasses, more particularly to a pair of clip-on eyeglasses that is adapted to be mounted on a pair of main eyeglasses.

### BACKGROUND

Strong ultraviolet light may cause damage to human eyes and also increase the probability of developing various eye problems such as cataracts. For this reason, many individuals opt to wear sunglasses to protect their eyes. However, individuals who already wear eyeglasses for nearsightedness or farsightedness must either wear contact lenses before putting on the sunglasses, or wear sunglasses that are already equipped with corrective lenses. An alternative solution is to have a pair of clip-on eyeglasses removably attached to a pair of eyeglasses.

Current clip-on eyeglasses usually include an adjusting unit and a pair of rims connected to the adjusting unit. When mounting the clip-on eyeglasses onto the eyeglasses, a user may adjust the distance between the two rims of the clip-on eyeglasses through the adjusting unit so that the clip-on eyeglasses can fit eyeglasses of different sizes. However, a problem that tends to occur during adjustment of the distance between the two rims, is that the two rims is prone to rotating or swinging back and forth relatively to each other, making it rather difficult for the clip-on eyeglasses to be correctly mounted on the pair of eyeglasses.

### SUMMARY

Therefore, an object of the disclosure is to provide a pair of clip-on eyeglasses that can alleviate at least one of the drawbacks of the prior art.

According to one aspect of the disclosure, a pair of clip-on eyeglasses adapted to be mounted on a pair of main eyeglasses includes two rims and a bridge device.

Each of the two rims includes a rim body and a fixation unit for mounting the rim body on the main eyeglasses.

The bridge device includes a main body and a connecting unit.

The main body has a first end portion and a second end portion opposite to the first end portion, and is formed with a slide groove that extends in an extending direction (X) between the first and second end portions and that has a non-circular cross section perpendicular to the extending direction (X).

The connecting unit has a first connecting element and a second connecting element.

The first connecting element has a first rod member that extends in the extending direction (X) away from the main body and that is connected to one of the rims.

The second connecting element has a slide block member, a second rod member, and a resilient member. The slide block member is slidable and non-rotatable along the slide groove in the extending direction (X) and has a non-circular cross section perpendicular to the extending direction (X). The second rod member is connected to the slide block member of the second connecting element, extends away from the main body, and is connected to the other one of the rims. The resilient member is sleeved on the second rod member and has a first end abutting against the second end portion, and a second end abutting against the slide block member of the second connecting element, for biasing the slide block member of the second connecting element away from the second end portion.

According to another aspect of the disclosure, a bridge device adapted to be mounted between two rims of a pair of clip-on eyeglasses includes a main body and a connecting unit.

The main body has a first end portion and a second end portion opposite to the first end portion, and is formed with a slide groove that extends in an extending direction (X) between the first and second end portions and that has a non-circular cross section perpendicular to the extending direction (X).

The connecting unit has a first connecting element and a second connecting element.

The first connecting element has a first rod member that extends in the extending direction (X) away from the main body for being connected to one of the rims.

The second connecting element has a slide block member, a second rod member, and a resilient member. The slide block member is slidable and non-rotatable along the slide groove in the extending direction (X) and has a non-circular cross section perpendicular to the extending direction (X). The second rod member is connected to the slide block member of the second connecting element, and extends away from the main body for being connected to the other one of the rims. The resilient member is sleeved on the second rod member and has a first end abutting against the second end portion, and a second end abutting against the slide block member of the second connecting element, for biasing the slide block member of the second connecting element away from the second end portion.

### BRIEF DESCRIPTION OF THE DRAWINGS

Other features and advantages of the disclosure will become apparent in the following detailed description of the embodiment with reference to the accompanying drawings, of which:

FIG. 1 is an assembled perspective view of a first embodiment of a pair of clip-on eyeglasses according to the present disclosure;

FIG. 2 is an exploded perspective view of a bridge device of the first embodiment;

FIG. 3 is an assembled perspective view of the bridge device of the first embodiment;

FIG. 4 is a sectional view of the bridge device of the first embodiment taken along a line IV-IV in FIG. 3;

FIG. 5 is an assembled perspective view of a second embodiment of the pair of clip-on eyeglasses according to the present disclosure;

FIG. 6 is an exploded perspective view of a bridge device of the second embodiment;

FIG. 7 is a sectional view of the bridge device of the second embodiment taken along a line VII-VII in FIG. 5;

FIG. 8 is an assembled perspective view of a third embodiment of the pair of clip-on eyeglasses according to the present disclosure;

FIG. 9 is an exploded perspective view of a bridge device of the third embodiment; and

FIG. 10 is a sectional view of the bridge device of the third embodiment taken along a line X-X in FIG. 8.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

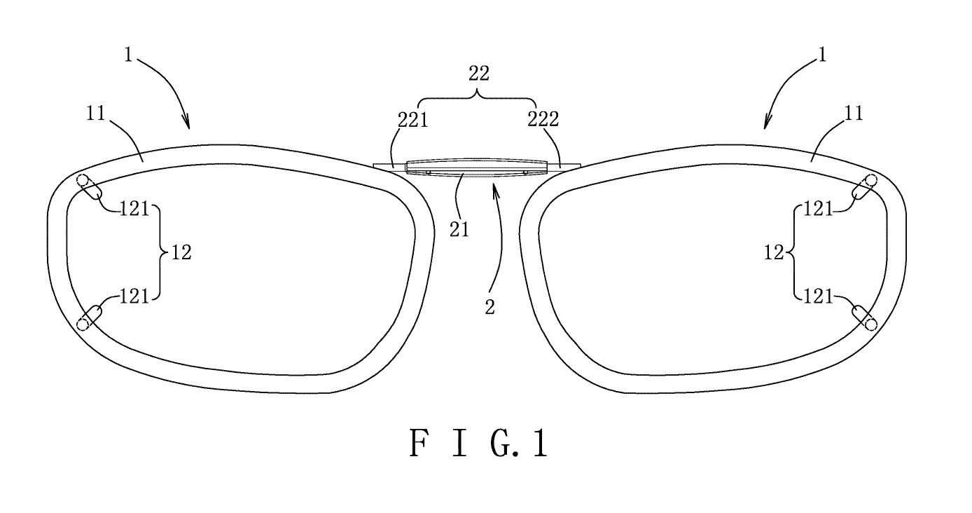

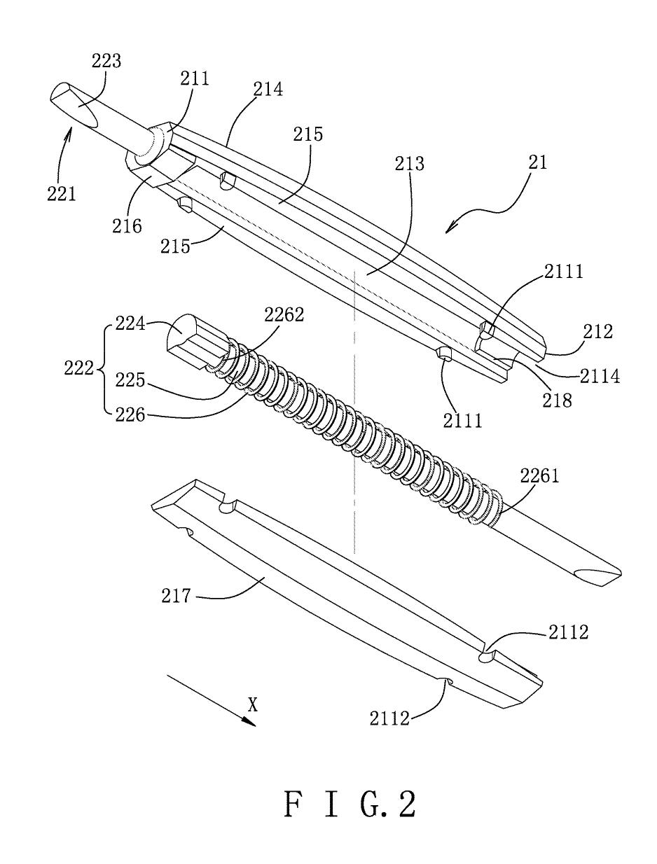

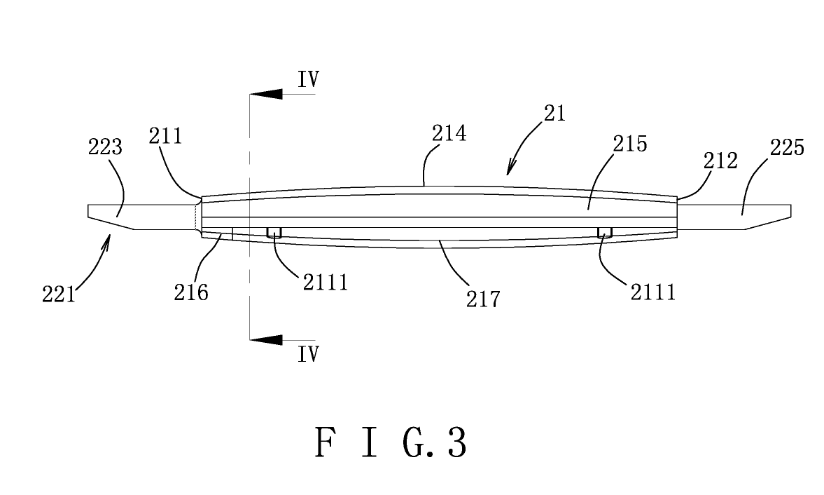

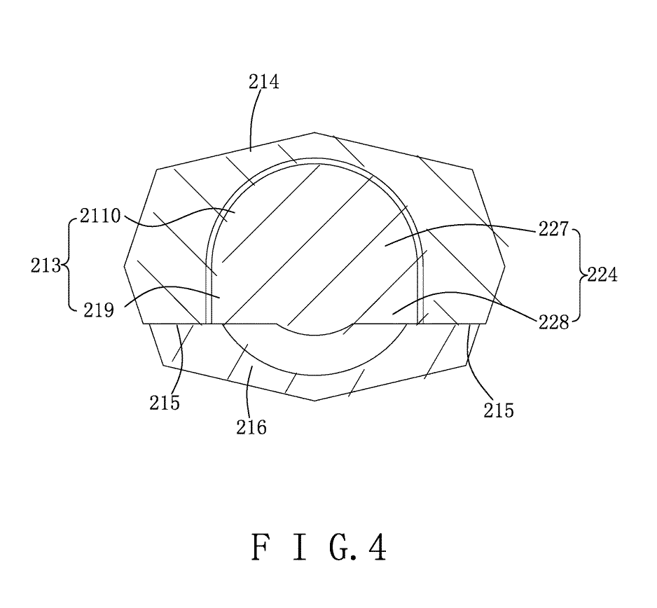

As shown in FIGS. 1 to 4, a first embodiment of a pair of clip-on eyeglasses according to the present disclosure is adapted to be mounted on a pair of main eyeglasses (not shown in the Figures), and includes two rims 1 and a bridge device 2.

Each of the rims 1 includes a rim body 11 and a fixation unit 12 for mounting the rim body 11 on the main eyeglasses. In certain embodiments, the fixation unit 12 of each of the rims 1 may include at least one clip member 121 for being clipped on the main eyeglasses. In this embodiment, the fixation unit 12 of each of the rims 1 includes two of the clip members 121.

The bridge device 2 includes a main body 21 and a connecting unit 22.

The main body 21 has a first end portion 211 and a second end portion 212 opposite to the first end portion 211. The main body 21 is further formed with a slide groove 213 that extends in an extending direction (X) between the first and second end portions 211, 212, and that has a non-circular cross section perpendicular to the extending direction (X).

In this embodiment, the main body 21 is shaped as an elongated and hollowed rod, and further has a base wall 214, two side walls 215 extending from two opposite lateral sides of the base wall 214 at an angle, and a connecting wall 216 connecting the base wall 214 and the side walls 215 and defining the first end portion 211. The base wall 214, the side walls 215, and the connecting wall 216 cooperate to define the slide groove 213 of the main body 21.

Moreover, in this embodiment, the bridge device further includes a cover body 217 that is coupled removably to the main body 21 and that covers the slide groove 213 of the main body 21. Furthermore, one of the main body 21 and the cover body 217 is provided with at least one positioning protrusion 2111, and the other one of the main body 21 and the cover body 217 is provided with at least one positioning recess 2112 that fittingly engages the positioning protrusion 2111 so as to removably connect the main body 21 and the cover body 217. In this embodiment, the main body 21 is provided with a plurality of the positioning protrusions 2111 at the side walls 215, and the cover body 217 is provided with a plurality of the positioning recesses 2112.

The connecting unit 22 has a first connecting element 221 and a second connecting element 222.

The first connecting element 221 has a first rod member 223 extending in the extending direction (X) away from the first end portion 211 of the main body 21 and connected to one of the rims 1. In this embodiment, the first rod member 223 is connected to the connecting wall 211 of the main body 21.

The second connecting element 222 has a slide block member 224, a second rod member 225, and a resilient member 226. The slide block member 224 is slidable and non-rotatable along the slide groove 213 in the extending direction (X) and has a non-circular cross section perpendicular to the extending direction (X). The second rod member 225 is connected to the slide block member 224 of the second connecting element 222, and thus, is movable with the slide block member 224. The second rod member 225 extends away from the main body 21, and is connected to the other one of the rims 1. The resilient member 226 is sleeved on the second rod member 225 and has a first end 2261 abutting against the second end portion 212 of the main body 21 and a second end 2262 abutting against the slide block member 224 of the second connecting element 222 for biasing the slide block member 224 of the second connecting element 222 away from the second end portion 212 of the main body 21.

In certain embodiments, the second rod member 225 and the slide block member 224 of the second connecting element 222 are integrally formed as one piece so as to reduce the amount of components and time required for assembly. The first rod member 223 of the first connecting member 221 may be integrally formed as one piece with the main body 21.

In this embodiment, the main body 21 further has an opening 2114 that is formed at the second end portion 212 of the main body 21 and that is in spatial communication with the slide groove 213 of the main body 21. The second rod member 225 of the second connecting element 222 extends in the slide groove 213 through the opening 2114 and away from the main body 21.

In certain embodiments, the second end portion 212 of the main body 21 is provided with a stopper portion 218 so as to prevent the slide block member 224 of the second connecting element 222 from being completely separated from the main body 21. Moreover, the first end 2261 of the resilient member 226 abuts against the stopper portion 218, and the second end 2262 of the resilient member 226 abuts against the slide block member 224 of the second connecting element 222, for biasing the slide block member 224 of the second connecting element 222 away from the second end portion 212 of the main body 21. In this embodiment, the stopper portion 218 is a member that radially extends from the base wall 214, the side walls 25 and the cover body 217.

In certain embodiments, the slide groove 213 of the main body 21 has at least one limiting portion 219 and a channel portion 2110 that is in spatial communication with the at least one limiting portion 219. The slide block member 224 of the second connecting element 222 further has a main portion 227 that is received in the channel portion 2110 of the slide groove 213 of the main body 21, and at least one rotation blocking portion 228 that is connected to the main portion 227 and that is slidably and non-rotatably received in the at least one limiting portion 219 of the slide groove 213 of the main body 21, so as to allow the main portion 227 to be slidably and non-rotatably movable along the slide groove 213 in the extending direction (X).

In this embodiment, the at least one rotation blocking portion 228 of the slide block member 224 of the second connecting element 222 has a contour generally complementary to that of the at least one limiting portion 219 of the slide groove 213 of the main body 21. Similarly, the main portion 227 of the slide block member 224 of the second connecting element 222 has a contour generally complementary to that of the channel portion 2110 of the slide groove 213 of the main body 21.

Moreover, in this embodiment, the main portion 227 of the slide block member 224 of the second connecting element 222 has a generally semi-circular cross section perpendicular to the extending direction (X), and the rotation blocking portion 228 of the slide block member 224 of the second connecting element 222 has a generally rectangular cross section perpendicular to the extending direction (X).

It should be noted that, the cross section of each of the main portion 227 and the at least one rotation blocking portion 228 may be in a shape other than generally semi-circular and generally rectangular, respectively. In certain embodiments, each of the slide groove 213 of the main body 21 and the slide block member 224 of the second connecting element 222 may have a, e.g., rectangular, triangular, or trapezoid cross section perpendicular to the extending direction (X).

In this disclosure, since the rotation blocking portion 228 is slidably and non-rotatably received in the limiting portion 219 and is confined in the limiting portion 219, the slide block member 224 of the second connecting element 222 is unlikely to rotate in the slide groove 213.

When in use, the rims 1 which are connected to the bridge device 2 are pulled away from each other, so that the slide block member 224 of the second connecting element 222 slides toward the second end portion 212 in the slide groove 213 along the extending direction (X). At this moment, the resilient element 226 of the second connecting element 222 is compressed by the slide block member 224 of the second connecting element 222 and the stopper portion 218. The clip members 121 of the fixation units 12 of the rims 1 can then be clipped on the main eyeglasses. In this way, the clip-on eyeglasses can be mounted on the main eyeglasses at the desired position.

When the pair of clip-on eyeglasses is removed from the main eyeglasses, the resilient member 226 biases the slide block member 224 away from the second end portion 212 of the main body 21 toward the first end portion 211 of the main body 21, such that the clip-on eyeglasses is restored to its original state. It should be noted that the clip-on eyeglasses of this embodiment can be mounted on sunglasses or 3-D glasses according to the practical need.

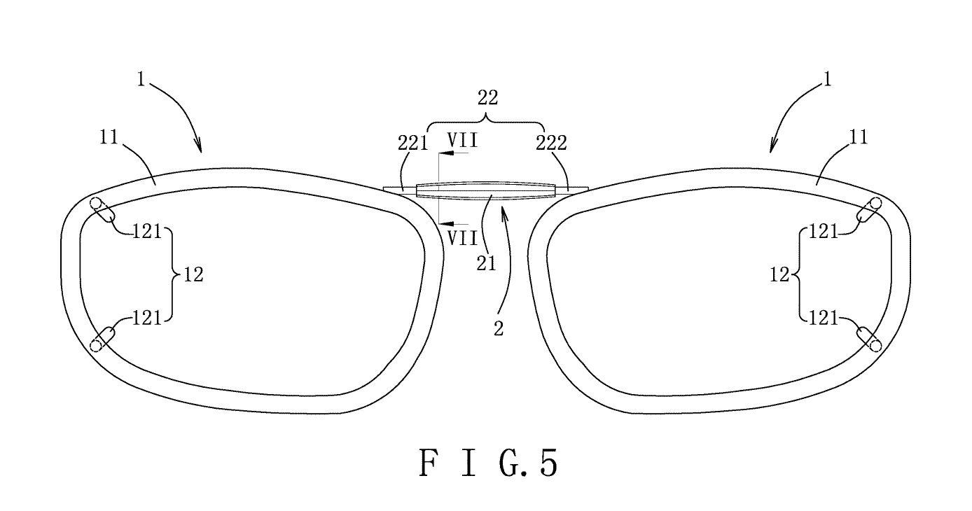

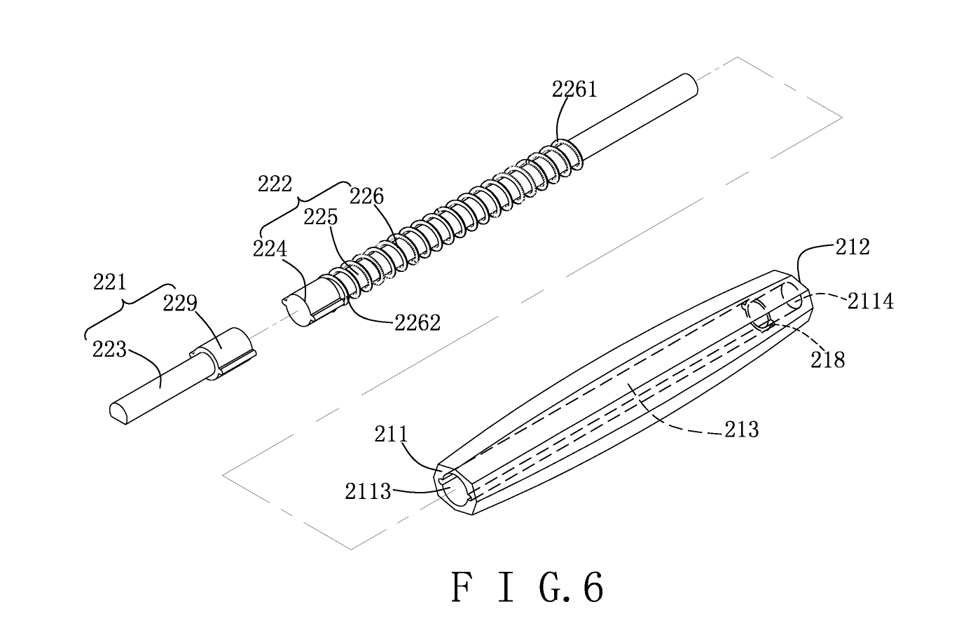

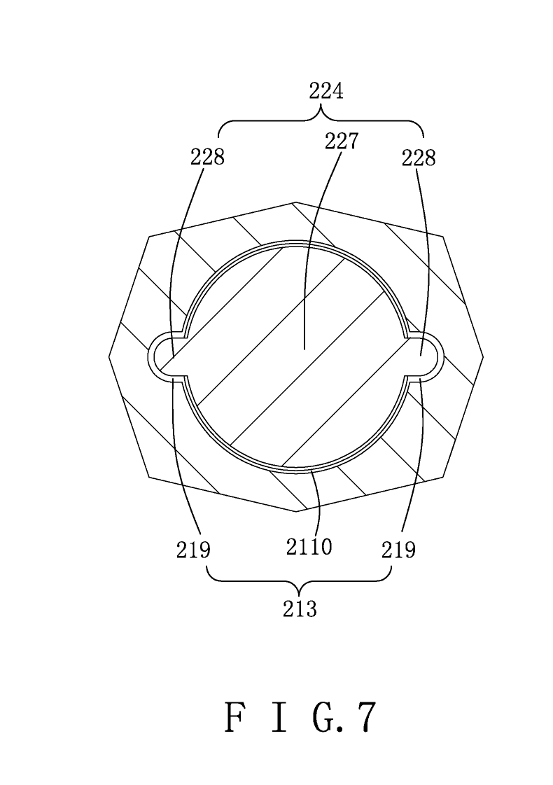

Referring to FIGS. 5 to 7, a second embodiment of the pair of clip-on eyeglasses according to the present disclosure is generally similar to the first embodiment, but differs from the first embodiment in the following ways.

The main body 21 of the bridge device 2 of the second embodiment has a first opening 2113 formed at the first end portion 211 of the main body 21 and a second opening 2114 formed at the second end portion 212 of the main body 21 that are each in spatial communication with the slide groove 213.

In this embodiment, the first connecting element 221 further has a first connecting portion 229 that removably seals the first opening 2113 of the main body 21. The first rod member 223 is connected to the first connecting portion 229 of the first connecting element 221, extends in the extending direction (X) away from the main body 21 and through the first opening 2113, and is connected to the one of the rims 1.

The slide groove 213 has a non-circular cross section perpendicular to the extending direction (X). In this embodiment, the slide block member 224 of the second connecting element 222 has two of the rotation blocking portions 228, and accordingly, the slide groove 213 has two of the limiting portions 219. Since each of the rotation blocking portions 228 is slidably and non-rotatably received and confined in a respective one of the limiting portions 219, the slide block member 224 of the second connecting element 222 is unlikely to rotate in the slide groove 213.

In this embodiment, the rotation blocking portions 228 protrude from a circumference of the main portion 227 of the second connecting element 222. To be specific, the rotation blocking portions 228 protrude from opposite sides of a circumference of the main portion 227. In addition, the main portion 227 of the slide block member 224 of the second connecting element 222 has a contour generally complementary to that of the channel portion 2110 of the slide groove 213 of the main body 21, and each of the rotation blocking portions 228 has a contour generally complementary to that of a respective one of the limiting portions 219.

Moreover, in this embodiment, the main portion 227 of the slide block member 224 of the second connecting element 222 has a generally circular cross section perpendicular to the extending direction (X).

It should be noted that, the cross section of the main portion 227 of the slide block member 224 of the second connecting element 222 may vary based on actual requirements. Moreover, the numbers of the rotation blocking portions 228 and the limiting portions 219 may also vary based on actual need.

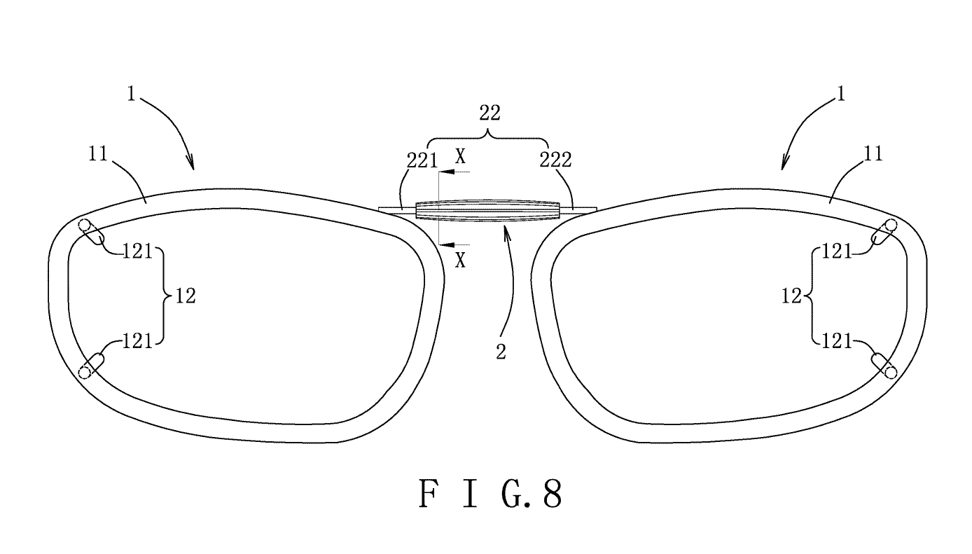

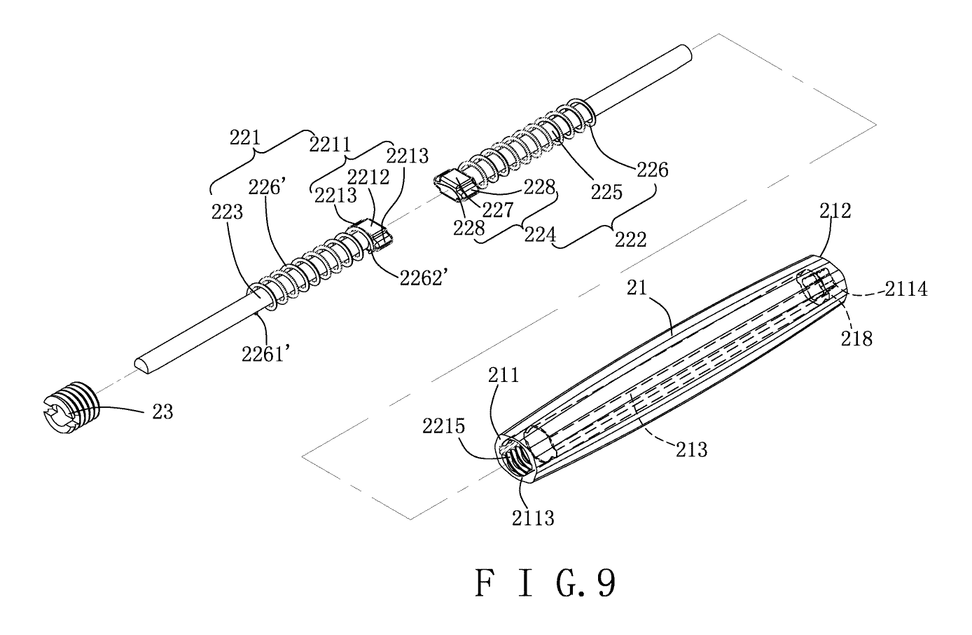

Referring to FIGS. 8 to 10, a third embodiment of the pair of clip-on eyeglasses according to the present disclosure is generally similar to the second embodiment, but differs from the second embodiment in the following ways.

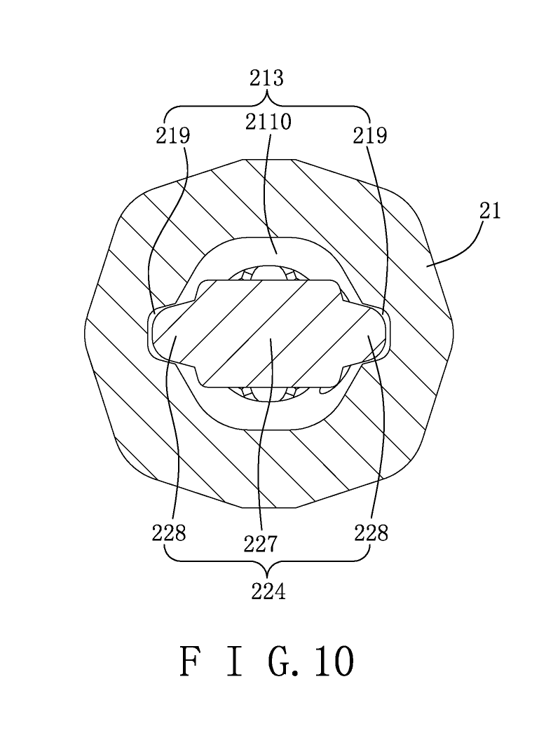

The structure of the second connecting element 222 of this embodiment is generally the same as that of the second embodiment, except that, in this embodiment, the main portion 227 of the second connecting element 222 has a generally rectangular cross section perpendicular to the extending direction (X) (see FIG. 10).

The first connecting element 221 further has a slide block member 2211 and a resilient member 226′. The slide block member 2211 is slidable and non-rotatable along the slide groove 213 of the main body 21 in the extending direction (X) and has a non-circular cross section perpendicular to the extending direction (X). The first rod member 223 is connected to the slide block member 2211 of the first connecting element 221, and thus, is movable with the slide block member 2211 of the first connecting element 221. The first rod member 223 extends in the extending direction (X) away from the main body 21 and through the first opening 2113, and is connected to the one of the rims 1. The resilient member 226′ is sleeved on the first rod member 223 for biasing the slide block member 2211 of the first connecting element 221 away from the first end portion 211.

In this embodiment, the first end portion 211 of the main body 21 is formed with an inner thread 2215 proximate to the first opening 2113. The bridge device 2 further includes a nut 23 removably threaded on the inner thread 2113 so as to prevent the first connecting element 221 from being completely separated from the main body 21. The resilient member 226′ of the first connecting element 221 has a first end 2261′ abutting against the nut 23, and a second end 2262′ abutting against the slide block member 2211 of the first connecting element 221, for biasing the slide block member 2211 of the first connecting element 221 away from the first end portion 211 of the main body 21.

In this embodiment, the slide block member 2211 of the first connecting element 221 has a main portion 2212 that is received in the channel portion 2110 of the slide groove 213 of the main body 21, and at least one rotation blocking portion 2213 that is connected to the main portion 2212 and that is slidably and non-rotatably received and confined in the at least one limiting portion 219 of the slide groove 213 of the main body 21, so as to allow the main portion 2212 of the first connecting element 221 to be slidably and non-rotatably movable along the slide groove 213 in the extending direction (X).

In this embodiment, the at least one rotation blocking portion 2213 of the slide block member 2211 of the first connecting element 221 protrudes from a circumference of the main portion 2212. In addition, the rotation blocking portion 2213 has a contour generally complementary to that of the limiting portion 219 of the slide groove 213 of the main body 21. In this embodiment, the slide block member 2211 of the first connecting element 221 has two of the rotation blocking portions 2213 which respectively protrude from opposite sides of a circumference of the main portion 2212 of the slide block member 2211 of the first connecting element 221.

Moreover, in this embodiment, the main portion 2212 of the slide block member 2211 of the first connecting element 221 has a generally rectangular cross section perpendicular to the extending direction (X).

It should be noted that the cross section of the main portion 2212, 227 of each of the slide block members 2211, 224 of the first and second connecting elements 221, 222 may be in a shape other than generally rectangular, and may vary based on actual requirements.

In summary, due to the particular structural designs of the slide groove 213 and the slide block member 224 according to the present disclosure, the rims 1 can be adjusted in a steady manner, such that the rims 1 do not greatly rotate or swing back and forth relative to each other.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A pair of clip-on eyeglasses adapted to be mounted on a pair of main eyeglasses, said clip-on eyeglasses comprising:
two rims, each of which includes a rim body, and a fixation unit for mounting said rim body on the main eyeglasses, and
a bridge device including
a main body having a first end portion and a second end portion opposite to said first end portion, and formed with a slide groove that extends in an extending direction (X) between said first and second end portions and that has a non-circular cross section perpendicular to the extending direction (X), and
a connecting unit having
a first connecting element that has a first rod member extending in the extending direction (X) away from said main body and connected to one of said rims, and
a second connecting element that has
a slide block member being slidable and non-rotatable along said slide groove in the extending direction (X) and having a non-circular cross section perpendicular to the extending direction (X),
a second rod member connected to said slide block member of said second connecting element, extending away from said main body, and connected to the other one of said rims, and
a resilient member sleeved on said second rod member and having a first end abutting against said second end portion and a second end abutting against said slide block member of said second connecting element for biasing said slide block member of said second connecting element away from said second end portion.

2. The clip-on eyeglasses as claimed in claim 1, wherein said slide groove of said main body has at least one limiting portion and a channel portion that is in spatial communication with said at least one limiting portion, said slide block member of said second connecting element having a main portion that is received in said channel portion, and at least one rotation blocking portion that is connected to said main portion and that is slidably and non-rotatably received in said at least one limiting portion, so as to allow the main portion to be slidably and non-rotatably movable along said slide groove in the extending direction (X).

3. The clip-on eyeglasses as claimed in claim 2, wherein said at least one rotation blocking portion has a contour generally complementary to that of said at least one limiting portion.

4. The clip-on eyeglasses as claimed in claim 3, wherein said main portion of said slide block member of said second connecting element further has a generally semi-circular cross section perpendicular to the extending direction (X), said at least one rotation blocking portion having a generally rectangular cross section perpendicular to the extending direction.

5. The clip-on eyeglasses as claimed in claim 4, wherein said main body further has a base wall, two side walls extending from two opposite lateral sides of said base wall at an angle, and a connecting wall connecting said base wall and said side walls and defining said first end portion, said base wall, said side walls, and said connecting wall cooperating to define said slide groove of said main body, said first rod member being connected to said connecting wall.

6. The clip-on eyeglasses as claimed in claim 5, wherein said bridge device further includes a cover body that is coupled removably to said main body and that covers said slide groove of said main body.

7. The clip-on eyeglasses as claimed in claim 6, wherein one of said main body and said cover body is provided with at least one positioning protrusion, and the other one of said main body and said cover body is provided with at least one positioning recess that fittingly and respectively engages said positioning protrusion to connect said main body and said cover body.

8. The clip-on eyeglasses as claimed in claim 7, wherein said main body further has an opening formed at said second end portion, said opening being in spatial communication with said slide groove, said second rod member extending through said opening and away from said main body.

9. The clip-on eyeglasses as claimed in claim 8, wherein said second end portion of said main body is provided with a stopper portion so as to prevent said second connecting element from being completely separated from said main body, said first end of said resilient member abutting against said stopper portion and said second end of said resilient member abutting against said slide block member of said second connecting element for biasing said slide block member of said second connecting element away from said second end portion.

10. The clip-on eyeglasses as claimed in claim 2, wherein said rotation blocking portion protrudes from a circumference of said main portion.

11. The clip-on eyeglasses as claimed in claim 10, wherein said main portion of said slide block member of said second connecting element has a generally circular cross section perpendicular to the extending direction (X).

12. The clip-on eyeglasses as claimed in claim 10, wherein said main body further has a first opening formed at said first end portion and a second opening formed at said second end portion, said first connecting element further having a first connecting portion that removably seals said first opening, said first rod member being connected to said first connecting portion and extending away from said main body.

13. The clip-on eyeglasses as claimed in claim 11, wherein said second end portion of said main body further has a stopper portion so as to prevent said second connecting element from being completely separated from said main body, said first end of said resilient member abutting against said stopper portion and said second end of said resilient member abutting against said slide block member of said second connecting element for biasing said slide block member of said second connecting element away from said second end portion.

14. The clip-on eyeglasses as claimed in claim 10, wherein said first connecting element further has a slide block member being slidable and non-rotatable along said slide groove of said main body in the extending direction (X) and having a non-circular cross section perpendicular to the extending direction, and a resilient member sleeved on said first rod member for biasing said slide block member of said first connecting element away from said first end portion, said first rod member being connected to said slide block member of said first connecting element and extending away from said main body.

15. The clip-on eyeglasses as claimed in claim 13, wherein said slide block member of said first connecting element has a main portion that is received in said channel portion of said slide groove of said main body, and at least one rotation blocking portion that protrudes from a circumference of said main portion of said slide block member of said first connecting element and that is slidably and non-rotatably received in said limiting portion of said slide groove, so as to allow the main portion to be slidably and non-rotatably movable along said slide groove in the extending direction (X).

16. The clip-on eyeglasses as claimed in claim 15, wherein each of said main portion of said slide block member of said first and second connecting element has a generally rectangular cross section perpendicular to the extending direction (X).

17. The clip-on eyeglasses as claimed in claim 14, wherein said main body further has a first opening formed at said first end portion and a second opening formed at said second end portion, said first end portion being formed with an inner thread proximate to said first opening, said bridge device further including a nut removably threaded on said inner thread so as to prevent said first connecting element from being completely separated from said main body, said resilient member of said first connecting element having a first end abutting against said nut and a second end abutting against said slide block member of said first connecting element for biasing said slide block member of said first connecting element away from said first end portion.

18. The clip-on eyeglasses as claimed in claim 17, wherein said second end portion of said main body is provided with a stopper portion so as to prevent said second connecting element from being completely separated from said main body, said first end of said resilient member of said second connecting element abutting against said stopper portion and said second end of said resilient member of said second connecting element abutting against said slide block member of said second connecting element for biasing said slide block member of said second connecting element away from said second end portion.

19. The clip-on eyeglasses as claimed in claim 1, wherein said fixation unit of each of said rims includes at least one clip member adapted to be clipped on the main eyeglasses.

20. The clip-on eyeglasses as claimed in claim 1, wherein said second rod member and said slide block member of said second connecting element are integrally formed as one piece.

21. The clip-on eyeglasses as claimed in claim 1, wherein each of said slide groove of said main body and said slide block member of said second connecting element further has a rectangular cross section perpendicular to the extending direction (X).

22. A bridge device adapted to be mounted between two rims of a pair of clip-on eyeglasses, said bridge device comprising:
a main body having a first end portion and a second end portion opposite to said first end portion, and formed with a slide groove that extends in an extending direction (X) between said first and second end portions and that has a non-circular cross section perpendicular to the extending direction (X), and
a connecting unit having
a first connecting element that has a first rod member extending in the extending direction (X) away from said main body for being connected to one of the rims, and
a second connecting element that has
a slide block member being slidable and non-rotatable along said slide groove in the extending direction (X) and having a non-circular cross section perpendicular to the extending direction (X),
a second rod member connected to said slide block member of said second connecting element and extending away from said main body for being connected to the other one of the rims, and
a resilient member sleeved on said second rod member and having a first end abutting against said second end portion and a second end abutting against said slide block member of said second connecting element for biasing said slide block member of said second connecting element away from said second end portion.
